(19) United States
(12) Patent Application Publication
(10) Pub. No.: US 2007/0284312 A1
(43) Pub. Date: Dec. 13, 2007

(54) DISPOSAL SYSTEM FOR WASTE GENERATED DURING PLASTERING OF SWIMMING POOL

(75) Inventor: Larry Lee Lough, Liberty Township, OH (US)

Correspondence Address: WOOD, HERRON & EVANS, LLP, 2700 CAREW TOWER, 441 VINE STREET, CINCINNATI, OH, 45202, US

(73) Assignee: TRI-E TECHNOLOGIES, Cincinnati, OH (US)

(21) Appl. No.: 11/549,709

(22) Filed: Oct. 16, 2006

Related U.S. Application Data
(60) Provisional application No. 60/812,761, filed on Jun. 12, 2006.

(51) Int. Cl. C02F 1/52

(52) U.S. Cl. 210/724; 210/209

(57) ABSTRACT

A portable waste disposal system for cementuous slurry comprises a collapsible wire cage, a waterproof containment bag inside the wire cage and a filtration bag inside the waterproof containment bag. The system enables the cementuous slurry generated during the plastering of a swimming pool and pumped from inside a swimming pool to a location adjacent the pool be disposed of quickly and safely. The liquid generated during the process may be neutralized and left on site, thereby avoiding transport of such liquid.

### CROSS REFERENCE TO RELATED APPLICATIONS

This application claims the benefit of the filing of U.S. provisional Patent Application Ser. No. 60/812,761 filed Jun. 12, 2006 entitled “Disposal System for Waste Generated During Plastering of Swimming Pool”, which is fully incorporated by reference herein.

### FIELD OF THE INVENTION

This invention relates generally to the disposal of waste generated during the plastering of a swimming pool.

### BACKGROUND OF THE INVENTION

Thousands of swimming pools are built in the United States each day. Typically, a four inch concrete shell is laid and covered with a bond coat to seal the initial concrete shell. A concrete slurry made of Portland cement, aggregate and water is then mixed together and sprayed onto the sealed surface of the pool.

Workers using trowels then smooth the surface. After a predetermined time period, the surface of the pool is then pressure washed to expose the aggregate, often in the form of colored rock. During this pressure washing, a cementuous slurry or waste is generated which must be removed from inside the pool. This is commonly accomplished using a pump which pumps the cementuous slurry or waste to a location adjacent the pool, where it is allowed to harden before being removed.

Swimming pool construction, both residential and commercial, generates 20-25 percent of waste cementuous slurry during the plastering phase of construction. There are several methods of handling this waste cementuous slurry at the present. There are vacuum trucks that suck the waste slurry up and transport it to a sanitary landfill. A major problem with this method of disposal is the cost of the equipment, but more importantly, the cement has to be chemically treated to retard the set time so the truck can get to the landfill before the cement sets. There have been multiple instances where the cement sets up in the truck, causing major cleanup cost.

Another method of disposal currently being used is to build a wood shell consisting of four wooden walls 17 inches high. The length of the shell is generally 8 feet and the width is generally 4 feet. This shell is lined with a 6-10 mil plastic sheet or liner forming waterproof bottom and sides. The slurry is pumped from the pool during the plastering stage and allowed to set overnight to allow the cement to settle to the floor of the container (wooden shell and plastic liner). Fluid remains in the bag above the settled cement. The next day, a crew will come in and cut the plastic liner at the cement/water interface to drain the water off. The crew will then break the cement bed with hammers and haul the cement away.

There are several major problems with this methodology. First, the slurry is allowed to set overnight, which allows pets and children access to the slurry. The pH of the slurry water is 11.5-12.5, which makes it extremely basic in nature.

This fluid having such a high pH may cause injury such as permanent eye damage if allowed to contact the human eye. It is also now illegal in at least several western U.S. states to discharge fluid down a drain or onto a street at this pH range. Such fluid immediately may kill any grass or vegetation it contacts. Attempts to neutralize the fluid have generally been unsatisfactory because the cement has to be separated from the aqueous phase for neutralizing. The current box method does not allow for that separation.

Therefore, there is a need for a waste disposal system which may quickly and safely dispose of the cementuous slurry waste generated during the plastering of a swimming pool.

### SUMMARY OF THE INVENTION

The waste disposal system of the present invention comprises a bag support in the form of a collapsible wire cage movable between an erected condition or position and a collapsed condition or position, a waterproof containment bag adapted to be received within the erected cage and a filtration bag adapted to be received inside the waterproof containment bag. The system may further comprise a polymeric flocculating agent and a muriatic acid or any other acidic material.

The waterproof containment bag is a two ply bag having a bottom and four sides of the same dimensions. This waterproof containment bag may have outer dimensions which are approximately the same as the inside dimensions of the erected cage. In one embodiment, the inner ply of the waterproof containment bag is made of non-woven polypropylene and is waterproof. The outer ply is made of woven polypropylene. However, other materials may be used. The inner and outer plies may be sewn or otherwise secured together.

The filtration bag is generally smaller than the waterproof containment bag and fits therein. The filtration bag has a top having an opening, a bottom and four sides of the same dimensions. The filtration bag is two-ply having an inner ply and an outer ply. In one embodiment, the outer ply may be made entirely of woven polypropylene and have a perforated upper section and a non-perforated waterproof lower section. The inner ply of the filtration bag may have an upper and lower section sewn or otherwise secured together. The upper section of the inner ply may be made of a 50-micron filtration cloth which allows fluid to pass therethrough as long as the particles are less than 50 microns in diameter and the lower section of the inner play may be made of woven polypropylene which is waterproof.

In accordance with the practice of this invention, cementuous slurry is pumped inside the filtration bag where a flocculating agent is added to the slurry to accelerate the separation of the concrete and fluid and expedite the hardening of the concrete. The fluid is filtered by the filtration bag through a 50 micron filter media inner ply lining the upper portion of the filtration bag. The filtered fluid the passes into the containment bag where an acidic neutralizer is added to lower the pH of the fluid to a neutral or close to neutral condition.

The primary advantage of this invention is that it enables waste cement slurry created during the course of plastering a swimming pool to be quickly and inexpensively separated into its cement and liquid components and then safely disposed without any danger to persons, pets or the environment.

These and other advantages of the invention will be more readily apparent from the following description of the drawings, in which:

### DESCRIPTION OF THE INVENTION

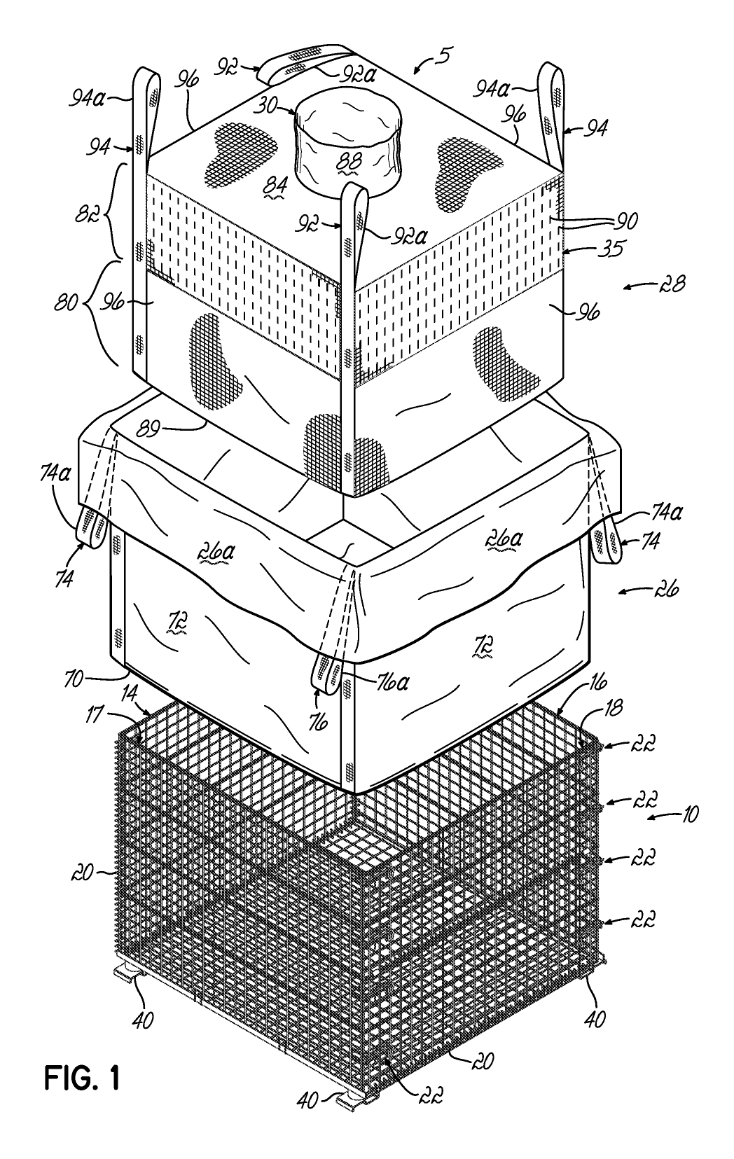

FIG. 1 is an exploded perspective view of one embodiment of a collapsible wire cage, containment bag and filtration bag of the present invention;

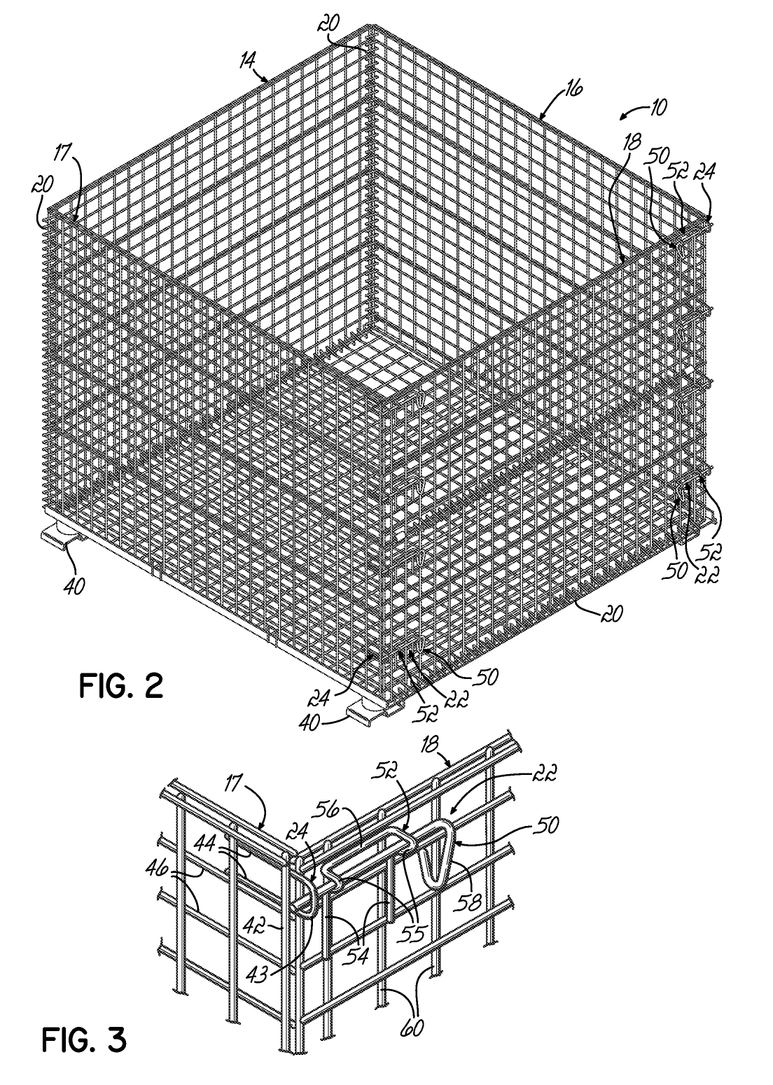

FIG. 2 is a perspective view of the collapsible wire cage of FIG. 1 in a fully erected condition;

FIG. 3 is an enlarged perspective view of a front corner of the collapsible wire cage of FIG. 2 illustrating the locking mechanism for holding the wire cage in an erected condition;

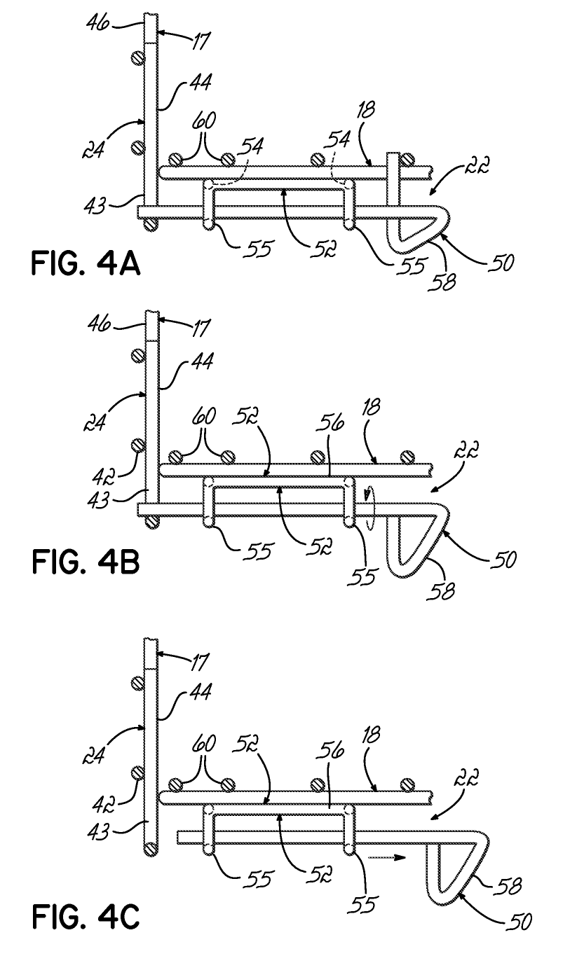

FIGS. 4A, 4B and 4C are top plan views of the locking mechanism of FIG. 3 illustrating the locking mechanism in locked condition, in partially unlocked condition, and fully unlocked conditions, respectively;

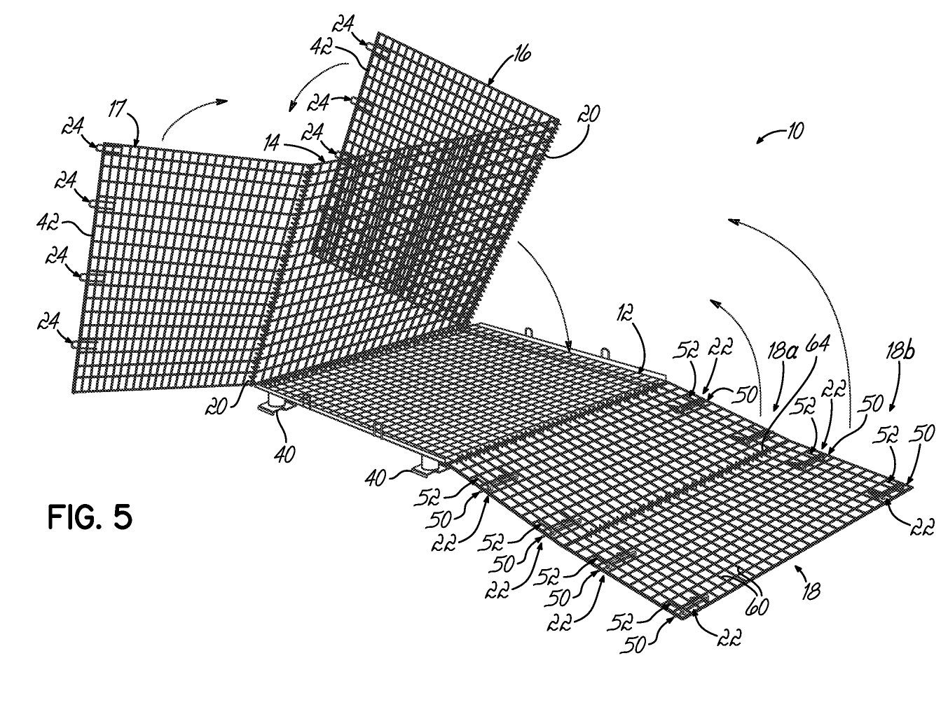

FIG. 5 is a perspective view of the collapsible wire cage of FIG. 2 in a partially collapsed condition;

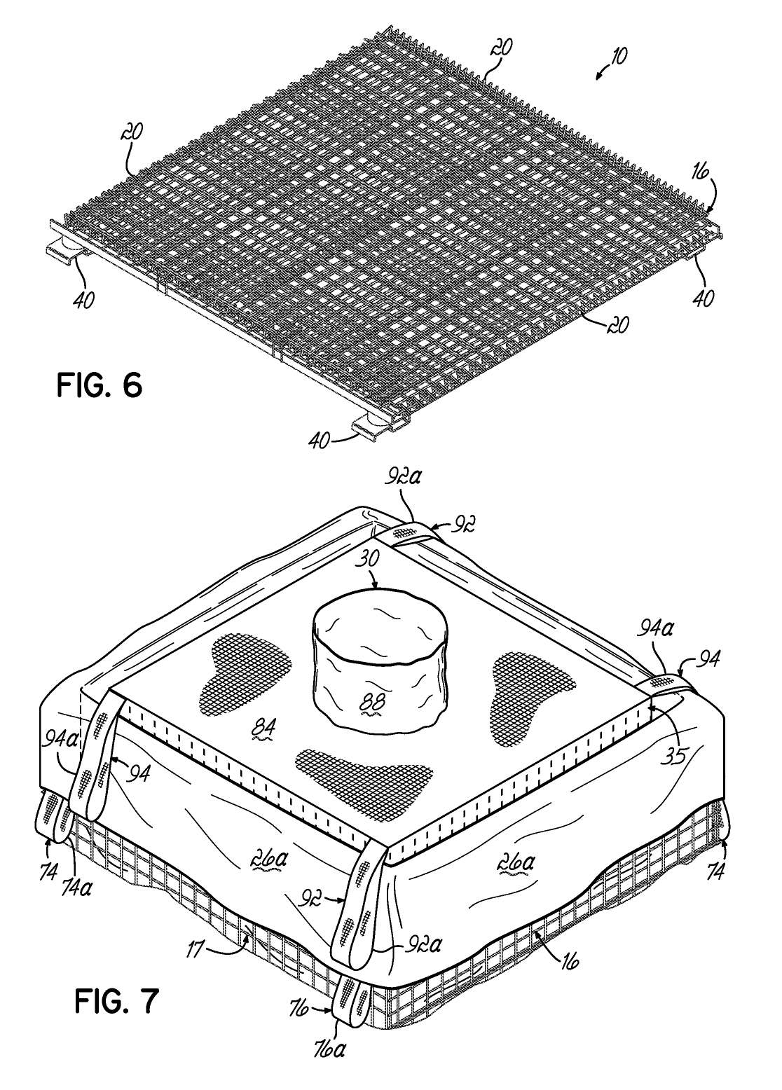

FIG. 6 is a perspective view of the wire cage of FIG. 2 in a fully collapsed condition;

FIG. 7 is a perspective view of the top portion of the erected wire cage of FIG. 2 having a containment bag and filtration bag located within the wire cage;

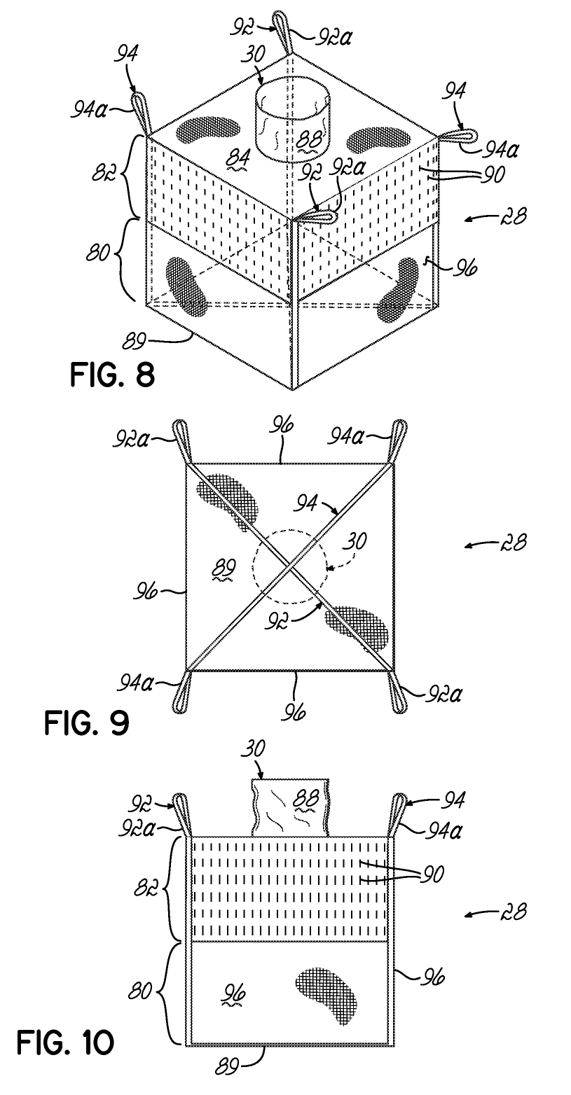

FIG. 8 is a perspective view of a filtration bag constructed in accordance with the present invention;

FIG. 9 is a bottom plan view of the filtration bag of FIG. 8;

FIG. 10 is a side elevational view of the filtration bag of FIG. 8;

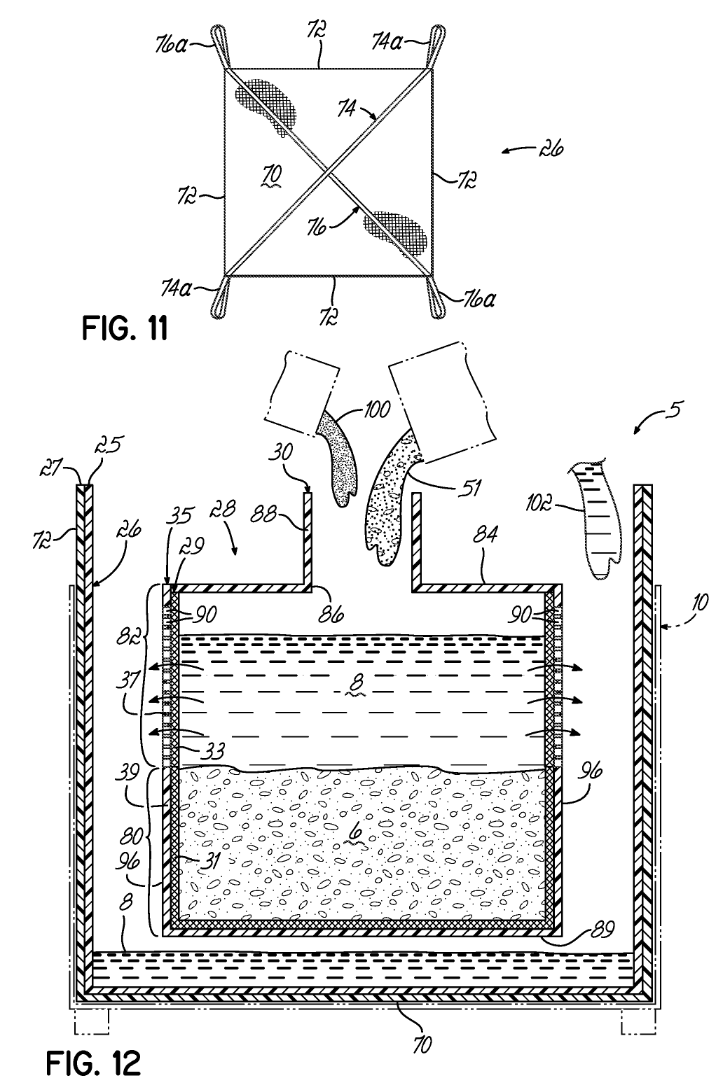

FIG. 11 is a bottom plan view of the containment bag of FIG. 1; and

FIG. 12 is a diagrammatic view through the center of the waste disposal system of FIG. 1 when the system is partially assembled.

### DETAILED DESCRIPTION OF THE INVENTION

With reference to the drawings and, particularly to FIG. 1, it will be seen that the waste disposal system 5 utilizes a collapsible wire cage or bag support 10, a containment bag 26 and a filtration bag 28 for separating cementuous slurry 51 pumped into the filtration bag 28 through a collar 30 of the bag. See FIG. 12. As explained more fully hereinafter, the cementuous slurry 51 pumped into the filtration bag 28 is separated into its cement and water components, 6, 8, respectively, the water or fluid component 8 removed from the filtration bag 28 and passed into the containment bag 26 where it is collected preparatory to disposal after having the pH content of the fluid lowered to a neutral or nearly neutral condition.

With reference now to FIG. 2, there is illustrated the collapsible wire cage 10 in an erected condition. In FIG. 6, this cage 10 is shown in a fully collapsed condition, and in FIG. 5, the cage 10 is shown in a partially collapsed condition. As best illustrated in FIG. 5, the wire cage 10 comprises a welded wire grid base or bottom panel 12 having front and rear border rods or wires pivotally connected by helical lacing wires 20 to a welded wire front panel 18 and a rear panel 14, respectively. Each of the front panel 18 and rear panel 14 also comprises a welded wire grid. The rear panel 14 has edgemost border rods or wires helically laced to edgemost border rods or wires of side panels 16, 17 such that the side panels 16, 17 may be pivoted relative to the back or rear panel 14. As may be seen most clearly in FIG. 5, when the wire cage 10 is collapsed, the front panel 18 is pivoted downwardly into contact with the top surface of the bottom panel 12. The side panels 16, 17 are pivoted inwardly one atop the other, and onto the back panel 14, then pivoted onto the top of the collapsed front and side panels to create a fully collapsed cage, as illustrated in FIG. 6. Other methods of collapsing the wire cage 10 may be used as desired.

In the illustrated embodiment, there are feet 40 attached to the underside of the bottom panel 12 at the four corners of the panel 12. These feet 40 may be welded or otherwise secured to the underside of the bottom panel 12 and, in turn, may be secured to a conventional wooden pallet or the bed of a truck for transportation from one site to another.

With reference now to FIGS. 2 and 3, it will be seen that there are four locking mechanisms 22 on each side of the front panel 18 which function to help maintain the cage 10 in its erected condition. These locking mechanisms 22 cooperate with loops 24 on the front edges 42 of the side panels 16 and 17 to secure the cage 10 in an erected condition. With particular reference to FIGS. 3 and 5, it will be seen that each of the loops 24 comprises a U-shaped section of wire having horizontal legs 44 welded to horizontal bars 46 of the side panels 16 and 17 and a loop portion 43 joining the horizontal legs 44. The loop portion 43 of each of these loops 24 extends forwardly from the front edge 42 of a side panel 16, 17 such that a locking pin 50 in cooperation with securement brackets 52 on the front side of the front panel 18 may secure the front panel 18 to the side panel 16, 17 in an erected condition of the cage 10. Each securement bracket 52 comprises a pair of spaced vertical legs 54 welded to vertical wires 60 of the front panel 18. The upper ends of each of these legs 54 terminate in U-shaped loops 55 which are connected through a cross bar 56, also welded to the front side of the vertical wires 60 of the front panel 18. When the locking pin 50 is inserted through the loops 55 of the securement bracket 52 and passed through a loop 24 of one of the side panels 16, 17, the front panel 18 is locked to the side panel. With reference to FIGS. 3 and 4A, 4B and 4C, it will be seen that each locking pin 50 terminates at its inner end in a generally hook-shaped loop 58 which, when rotated counterclockwise, as viewed in FIG. 3, may be disengaged from one of the vertical wires 60 of the front panel 18 and moved into a position in which the locking pin 50 may be moved inwardly toward the center of the front panel to disengage the free end of the pin from the locking loop 24 of the side panel. See FIG. 4C. Thereby, the front panel 18 with the locking pins 50 disengaged from the locking loops 24 be lowered to the position illustrated in FIG. 5 to collapse the cage 10.

With four such locking mechanisms 22 on each side of the front panel 18, it will be seen that the front panel 18 is easily secured to the side panels 16, 17 in the erected condition of the cage 10. Preferably, the front panel 18 is divided into two sections 18a, 18b intermediately of its height, which sections have laterally extending border rods or wires connected via a helical lacing wire 64 so as to enable those two sections 18a, 18b to pivot one relative to the other. Thereby, the upper half or section 18b of the front panel 18 may be unlocked and pivoted downwardly relative to the lower half or section 18a of the front panel 18 for purposes of enabling collected water in the containment bag 26 to more easily be emptied from the containment bag 26, as explained more fully hereinafter.

Although four locking mechanisms 22 are shown on each side of the front panel 18, it will be understood by those skilled in the art that any number of locking mechanisms of any known configuration or type may be used in accordance with the present invention.

As shown in FIGS. 11 and 12 one embodiment of the waterproof containment bag 26 is a two ply bag having a bottom 70 and four sides 72 of the same dimensions. The bottom 70 and each side 72 is two ply. As shown in FIG. 12, this waterproof containment bag 26 comprises a waterproof inner ply or liner 25 of non-woven polypropylene approximately 6 to 10 millimeters in thickness and an outer ply 27 primarily for strength made of woven polypropylene of a thickness of approximately six millimeters. The inner and outer plies 25, 27 are preferably sewn together along their upper edges (indicated by numeral 29) but may be joined in any desired manner. The plies 25, 27 may be other desired materials of any desired thickness.

As shown in FIGS. 1 and 11, two lifting straps 74, 76 are secured to the waterproof containment bag 26 on the outside thereof. Each lifting strap 74, 76 is formed into a lifting loop 74a, 76a at the top of the waterproof containment bag 26, extends down a corner or side of the waterproof containment bag 26 and up the opposite side or corner of the bag 26. The lifting straps 74, 76 form an X pattern at the bottom of the waterproof containment bag 26 for strength, as shown in FIG. 11. The lifting straps 74, 76 are preferably made of polypropylene and designed to lift 4000 lbs of weight. This type of bag is known in the industry as a rhino bag.

In one preferred embodiment, the waterproof containment bag 26 is 48 inches in length, 48 inches in width and 48 inches in height. However, any other size of waterproof containment bag may be used in accordance with the present invention.

The second bag of the waste disposal system 5 is the filtration bag 28 which functions to separate the liquid waste 8 of the cementuous slurry 51 from the solid waste or concrete 6 (see FIG. 12) created from the cementuous slurry. In one preferred embodiment, the filtration bag 28, like the waterproof containment bag 26, is a two ply bag. However, unlike the waterproof containment bag 26, the filtration bag 28 is divided into a waterproof lower section 80 and a porous upper section 82, such that water and any particle 50 microns or smaller may pass through the upper section 82 of the filtration bag 28 while cement and any particle 50 microns or larger remains in the filtration bag 28.

In one embodiment the filtration bag 28 is a two ply bag having a top 84 with an opening 86 surrounded by a neck 88, a bottom 89 and four sides 96 of the same dimensions. The opening 86, in one embodiment, has a diameter of approximately 12 inches. As shown in FIG. 12, the lower section 80 of the filtration bag 28 has an inner ply 31 and an outer ply 39 while the upper section 82 of the filtration bag 28 has an inner ply 33 and an outer ply 37.

The inner ply or liner 29 of the filtration bag 28 comprises a lower section 31 approximately 24 inches in height of waterproof non-woven polypropylene and an upper section 33 twelve inches in height of 50 micron filter cloth sewn or otherwise secured around the lower edge to the upper edge of the lower section 31 of the inner ply 29. Other size filtration cloths may be used in the upper section 33 of the inner ply of the filtration bag 28 if desired and the lower section 31 of the inner ply 29 of the filtration bag 28 may be made of any other suitable waterproof or leakproof material.

The outer ply 35 of the filtration bag 28 comprises an upper section 37 which is perforated as by cuts or slits 90 to allow the particles 50 microns or smaller which have passed through the filtration cloth of the upper section 31 of the inner ply 29 of the filtration bag 28 to pass through the outer ply 35 of the upper section 37 of the filtration bag 28. The lower section 39 of the outer ply 35 of the filtration bag 28 is waterproof and constructed primarily for strength. Both sections 37, 39 of the outer ply 35 of the filtration bag 28 are preferably made of non-woven polypropylene but may be made of any suitable material. The inner and outer plies 29, 35 of the filtration bag 28 are sewn together along their upper edges but may be joined in any desired manner.

The filtration bag 28 has two lifting straps 92, 94, each being formed into a lifting loop 92a, 94a at the top of the filtration bag 28. These straps 92, 94 each extend down the sides or corners of the waterproof containment bag 28 and form an X pattern at the bottom of the filtration bag 28. See FIG. 9. The lifting straps 92, 94 are preferably made of polypropylene and designed to lift 3000 lbs of weight. This type of bag is also known in the industry as a rhino bag. In one preferred embodiment, the filtration bag 28 is 36 inches in length, 36 inches in width and 36 inches in height. However, another size or configuration of filtration bag may be used in accordance with the present invention.

In use, one or more individuals erect the wire cage 10 from its collapsed condition (FIG. 6) at a desired location, which is commonly adjacent the swimming pool being plastered. The waterproof containment bag 26 is placed inside the erected wire cage 10 with an upper portion 26a of the waterproof containment bag 26 being wrapped over the upper edge of the erected wire cage and located outside the erected cage 10. If desired, this portion of the waterproof containment bag 26 may be secured to the erected wire cage 10 outside the cage.

The filtration bag 28 is then placed inside the waterproof containment bag 26, the neck 88 of the filtration bag 26 being adapted to be attached to the end of a hose to receive the cementuous slurry. The loops 92a, 94a of the lifting straps 92, 94 of the filtration bag 28 are preferably secured to the erected wire cage 10 by bungee straps or other conventional fasteners. A fixed quantity of a polymeric flocculating agent 100 is introduced into the interior of the filtration bag 28 via opening 86. See FIG. 12. A gallon is commonly used of a product sold under the trademark SLURRY MATE produced by Pebble Technology Incorporated of Scottsdale, Ariz. The purpose of the polymeric flocculating agent is to accelerate the separation of the cement 6 from the water or liquid 8, thus allowing the liquid 8 to rise to the top of the cement 6 and filter through the upper section 82 of the filtration bag 28 and pass into and be collected in the waterproof containment bag 26. The cement, i.e., any particles larger than 50 microns, remain in the lower section 80 of the filtration bag 28 and solidify. Once a certain amount of time has passed the filtration bag filled with cement may be removed from the waterproof containment bag.

The next step in the process is to measure the pH of the filtered fluid waste which has been filtered and is now located in the waterproof containment bag 26. The pH may be checked or measured with any pool pH test strip which is available at most pool supply stores or locations. If the pH reading is high, muriatic acid or any other acidic material 102 may be added to the fluid inside the waterproof containment bag 26. Once the pH is in the range of 6.5-7.5 (neutral), one or more sides of the erected wire cage 10 may be lowered, thereby allowing the neutralized fluid 8 to flow out from inside the waterproof containment bag 26 onto the lawn or ground. Due to the neutral pH of such fluid, it is, in most places, lawful and safe to empty this fluid in such a manner. This avoids workers having to transport the fluid which may weigh as much as 4000 pounds. The remaining cement 6 is contained in the disposable filtration bag 28 and may be hoisted onto a delivery truck such as the same one which delivered the raw materials to the pool construction site. There is no overnight waiting for settling nor is there any chance for children or pets to get into the sealed bags.

The embodiments of the invention shown and described are for illustrative purposes only. For example, any cage, although preferably a collapsible solid cage, may be substituted for the wire cage described hereinabove. While those skilled in the art may make various other changes to, or additional embodiments of, the invention, none of those changes/embodiments shall be deemed to depart from the spirit of the invention. Thus, all such changes/embodiments shall be embraced by the scope of the invention as defined in the claims. Accordingly, the invention is to be limited only by the scope of the following claims and their equivalents.

I claim:

1. A waste disposal system for cementuous slurry comprising:
a collapsible cage;
a waterproof containment bag adapted to be received within the erected cage; and
a filtration bag adapted to be received with the waterproof containment bag.

2. The waste disposal system of claim 1 wherein said waterproof containment bag is of approximately the same outside dimension as the inside dimension of said collapsible cage.

3. The waste disposal system of claim 1 wherein said waterproof containment bag has a bottom and four sides of the same dimensions.

4. The waste disposal system of claim 1 wherein said waterproof containment bag has an inner ply and an outer ply.

5. The waste disposal system of claim 1 wherein said waterproof containment bag is approximately 48 inches in length by 48 inches in width by 48 inches in height.

6. The waste disposal system of claim 4 wherein the outer ply of the waterproof containment bag is made of woven polypropylene.

7. The waste disposal system of claim 6 wherein said inner ply of the waterproof containment bag is waterproof.

8. The waste disposal system of claim 7 wherein the inner ply of the waterproof containment bag is made of non-woven polypropylene.

9. The waste disposal system of claim 4 wherein the inner and outer plies of the waterproof containment bag are sewn together.

10. The waste disposal system of claim 1 wherein said filtration bag has a top having an opening, a bottom, and four sides of the same dimensions.

11. The waste disposal system of claim 1 wherein said opening of said filtration bag has a diameter of approximately twelve inches.

12. The waste disposal system of claim 1 wherein said filtration bag is approximately 36 inches in length by 36 inches in width by 36 inches in height.

13. The waste disposal system of claim 1 wherein the filtration bag has an outer ply made of woven polypropylene and an inner ply.

14. The waste disposal system of claim 1 wherein the outer ply of the filtration bag has a waterproof lower section and an upper section which is perforated to allow fluid to flow through the outer ply of the filtration bag.

15. The waste disposal system of claim 1 wherein the inner ply of the filtration bag has an upper section made of 50-micron filtration cloth and a waterproof lower section, the upper and lower sections being joined together.

16. The waste disposal system of claim 1 wherein the upper and lower sections of each ply of the filtration bag are approximately 12 and 24 inches in height, respectively.

17. The waste disposal system of claim 1 further comprising a polypropylene neck secured onto the outer ply of the filtration bag around the opening.

18. The waste disposal system of claim 1 wherein the filtration bag has polypropylene lifting straps at the corners.

19. The waste disposal system of claim 1 wherein the waterproof containment bag has polypropylene lifting straps at the corners.

20. The waste disposal system of claim 1 further comprising an amount of flocculating agent adapted to be contained within the filtration bag.

21. A waste disposal system for cementuous slurry comprising:
a bag support;
a waterproof containment bag inside the bag support; and
a filtration bag inside the waterproof containment bag.

22. The waste disposal system of claim 21 wherein said bag support is a wire cage.

23. The waste disposal system of claim 21 wherein said waterproof containment bag has a bottom and four sides of the same dimensions.

24. The waste disposal system of claim 21 wherein said waterproof containment bag has an inner ply and an outer ply.

25. The waste disposal system of claim 21 wherein said waterproof containment bag is approximately 48 inches in length by 48 inches in width by 48 inches in height.

26. The waste disposal system of claim 24 wherein the outer ply of the waterproof containment bag is made of woven polypropylene.

27. The waste disposal system of claim 26 wherein said inner ply of the waterproof containment bag is waterproof.

28. The waste disposal system of claim 26 wherein the inner ply of the waterproof containment bag is made of non-woven polypropylene.

29. The waste disposal system of claim 24 wherein the inner and outer plies of the waterproof containment bag are sewn together.

30. The waste disposal system of claim 21 wherein said filtration bag has a top having an opening, a bottom and four sides of the same dimensions.

31. The waste disposal system of claim 30 wherein said opening of said filtration bag has a diameter of approximately 12 inches.

32. The waste disposal system of claim 21 wherein said filtration bag is approximately 36 inches in length by 36 inches in width by 36 inches in height.

33. The waste disposal system of claim 21 wherein the filtration bag has an outer ply made of woven polypropylene and an inner ply.

34. The waste disposal system of claim 21 wherein the outer ply of the filtration bag has a waterproof lower section and an upper section which is perforated to allow liquid to flow through the outer ply of the filtration bag into the waterproof containment bag.

35. The waste disposal system of claim 21 wherein the inner ply of the filtration bag has an upper section made 50 micron filtration cloth and a lower section made of a non-woven waterproof polypropylene, the upper and lower sections being joined together.

36. The waste disposal system of claim 21 wherein the upper and lower sections of each ply of the filtration bag are 12 and 24 inches in height, respectively.

37. The waste disposal system of claim 21 further comprising a polypropylene sleeve sewn onto the outer ply of the filtration bag around the opening.

38. The waste disposal system of claim 21 wherein the filtration bag has polypropylene lifting straps at the corners.

39. The waste disposal system of claim 21 wherein the waterproof containment bag has polypropylene lifting straps at the corners.

40. A filtration bag for use in a waste disposal system for disposing of cementuous slurry comprising:
a top having an inlet opening, a bottom and side walls;
said side walls of said filtration bag having an outer ply and an inner ply.

41. The filtration bag of claim 40 wherein said outer ply is made of woven polypropylene.

42. The waste disposal system of claim 41 wherein the outer ply of said filtration bag ha a waterproof lower section and an upper section which is perforated to allow fluid to flow through the outer ply of the filtration bag.

43. The waste disposal system of claim 40 wherein the inner ply of the filtration bag has an upper section made 50 micron filtration cloth and a lower section made of a non-woven waterproof polypropylene, the upper and lower sections being joined together.

44. The waste disposal system of claim 41 wherein the upper and lower sections of each ply of the filtration bag are 12 and 24 inches in height, respectively.

45. The waste disposal system of claim 41 further comprising a polypropylene sleeve sewn onto the outer ply of the filtration bag around the opening.

46. The waste disposal system of claim 41 wherein the filtration bag has polypropylene lifting straps at the corners.

47. A method of disposal of cementuous slurry waste, said method comprising:
placing a waterproof containment bag inside a bag support;
placing a filtration bag inside the waterproof containment bag, said filtration bag having a porous upper section and a waterproof lower section;
introducing cementuous slurry waste into the filtration bag; through a neck in the filtration bag;
filtering liquid cementuous slurry waste through the upper section of the filtration bag, the filtered liquid cementuous slurry waste passing into the waterproof containment bag; and
removing the filtration bag containing solid waste from the cementuous slurry waste from inside the waterproof containment bag.

48. The method of claim 47 which further comprises:
measuring the pH of the filtered liquid waste in the waterproof containment bag;
neutralizing the filtered liquid waste while it is inside the waterproof containment bag; and
removing the neutralized liquid from inside the waterproof containment bag.

49. The method of claim 47 wherein the step of neutralizing the filtered liquid waste comprises adding an acidic material to the liquid waste.

50. The method of claim 47 wherein the step of introducing flocculating agent into the interior of the filtration bag comprises introducing a gallon of liquid flocculating agent into the interior of the filtration bag.

51. The method of claim 47 which further comprises:
introducing a flocculating agent into the interior of the filtration bag to expedite the separation of solids and liquid contained in the cementuous slurry waste.

52. A method of disposal of cementuous slurry waste, said method comprising:
erecting a wire cage;
placing a waterproof containment bag inside said erected wire cage;
placing a filtration bag inside the waterproof containment bag, said filtration bag having a porous upper section and a waterproof lower section;
introducing flocculating agent into the interior of the filtration bag;
introducing cementuous slurry waste into the filtration bag through a neck in the filtration bag;
filtering liquid cementuous slurry waste through the upper section of the filtration bag, the filtered liquid cementuous slurry waste passing into the waterproof containment bag;
removing the filtration bag from inside the waterproof containment bag;
measuring the pH of the filtered liquid waste in the waterproof containment bag;
neutralizing the filtered liquid waste while it is inside the waterproof containment bag;
removing the neutralized fluid from inside the waterproof containment bag; and
collapsing the wire cage.

53. The method of claim 52 wherein the step of neutralizing the filtered liquid waste comprises adding acid to the liquid waste.

54. The method of claim 52 wherein the step of introducing flocculating agent into the interior of the filtration bag comprises introducing approximately a gallon of flocculating agent into the interior of the filtration bag.
